(19) United States
(12) Patent Application Publication
(10) Pub. No.: US 2019/0191119 A1
(43) Pub. Date: Jun. 20, 2019

(54) IMAGING DEVICE AND CONTROL METHOD

(71) Applicant: SONY CORPORATION, Tokyo (JP)

(72) Inventors: Masaru TAKAMOTO, KANAGAWA (JP); Shigetaka KUDO, KANAGAWA (JP)

(73) Assignee: Sony Corporation, Tokyo (JP)

(21) Appl. No.: 16/301,103

(22) PCT Filed: Feb. 10, 2017
(86) PCT No.: PCT/JP2017/004905

§ 371 Date: Nov. 13, 2018

(30) Foreign Application Priority Data
May 25, 2016 (JP) 2016-103856

(51) Int. Cl. H04N 5/378; H04N 5/357; H04N 5/3745; B60R 1/00

(52) U.S. Cl. CPC H04N 5/378; H04N 5/357; H04N 5/37455; B60R 2300/8093; B60R 2300/60; B60R 2300/105; B60R 1/00

(57) ABSTRACT

Provided is an imaging device including: an imaging section that includes a plurality of pixel circuits that perform photoelectric conversion; a first converting section that converts an analog signal output from the pixel circuit that constitutes the imaging section, into a digital signal; and a second converting section that converts an analog signal output from the pixel circuit that constitutes the imaging section, into a digital signal. A same reference signal used for analog-to-digital conversion is supplied to the first converting section and the second converting section, the first converting section and the second converting section convert the analog signal output from the same pixel circuit that constitutes the imaging section, into a digital signal, and one or both of the first converting section and the second converting section is/are able to adjust a gain of the analog signal to be converted into a digital signal.

### TECHNICAL FIELD

The present disclosure is related to an imaging device and a control method.

### BACKGROUND ART

The technology of aiming to reduce a circuit scale of a solid-state imaging device has been developed. As the technology with regard to the solid-state imaging device of aiming to reduce a circuit scale by including two analog-to-digital converting sections that convert analog pixel signals into digital signals with mutually-different reference signals, for example, the technology described in the following Patent Literature 1 is cited.

### CITATION LIST

### Patent Literature

Patent Literature 1: JP 2013-207433A

### DISCLOSURE OF INVENTION

### Technical Problem

For example, in the imaging device in which the technology described in Patent Literature 1 is used, in two analog-to-digital converting sections, analog signals output from pixels that perform photoelectric conversion, are converted into digital signals by mutually-different reference signals. Moreover, in the imaging device in which the technology described in Patent Literature 1 is used, digital signals having been converted in the two analog-to-digital converting sections are synthesized. Therefore, in the case where the technology described in Patent Literature 1 is used, since it is possible to obtain digital signals with a wider dynamic range by high dynamic range synthesis (hereinafter, denoted as “HDR” (High Dynamic Range imaging)), it is possible to attain making the image quality of a captured image obtained by imaging, higher.

However, for example, in the case where the technology described in Patent Literature 1 is used, at the time of converting analog signals into digital signals, two mutually-different reference signals become necessary.

In the present disclosure, proposed are a novel and improved imaging device capable of attaining making the image quality of a captured image obtained by imaging higher, and a control method.

### Solution to Problem

According to the present disclosure, there is provided an imaging device including: an imaging section that includes a plurality of pixel circuits that perform photoelectric conversion; a first converting section that converts an analog signal output from the pixel circuit that constitutes the imaging section, into a digital signal; and a second converting section that converts an analog signal output from the pixel circuit that constitutes the imaging section, into a digital signal. A same reference signal used for analog-to-digital conversion is supplied to the first converting section and the second converting section, the first converting section and the second converting section convert the analog signal output from the same pixel circuit that constitutes the imaging section, into a digital signal, and one or both of the first converting section and the second converting section is/are able to adjust a gain of the analog signal to be converted into a digital signal.

In addition, according to the present disclosure, there is provided a control method to be executed in an imaging device that includes an imaging section that includes a plurality of pixel circuits that perform photoelectric conversion, a first converting section that converts an analog signal output from the pixel circuit that constitutes the imaging section, into a digital signal, a second converting section that converts an analog signal output from the pixel circuit that constitutes the imaging section, into a digital signal, a first switching section that is electrically connected between the imaging section and the first converting section and switches the pixel circuit to be electrically connected to the first converting section, and a second switching section that is electrically connected between the imaging section and the second converting section and switches the pixel circuit to be electrically connected to the second converting section. A same reference signal used for analog-to-digital conversion is supplied to the first converting section and the second converting section, the first converting section and the second converting section convert the analog signal output from the same pixel circuit that constitutes the imaging section, or the analog signal output from the different pixel circuits that constitute the imaging section, into a digital signal, and one or both of the first converting section and the second converting section is/are able to adjust a gain of the analog signal to be converted into a digital signal. The control method includes a step of performing one or two or more of control of the gain in the first converting section capable of adjusting the gain, control of the gain in the second converting section capable of adjusting the gain, and control of switching of connection in the first switching section and the second switching section, on a basis of an operation signal corresponding to an operation of a user of the imaging device or a state of the imaging device.

### Advantageous Effects of Invention

According to the present disclosure, it is possible to attain making the image quality of a captured image obtained by imaging, higher.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a block diagram showing one example of a constitution of an imaging device according to the first embodiment.

FIG. 2 is an explanatory diagram for describing one example of a hardware constitution of an imaging section equipped in an imaging device according to the first embodiment.

FIG. 3 is an explanatory diagram for describing a converting circuit capable of adjusting a gain according to the present embodiment.

FIG. 4 is an explanatory diagram showing one example of a switching circuit according to the present embodiment.

FIG. 5 is an explanatory diagram for describing a converting circuit capable of adjusting a gain according to the present embodiment.

FIG. 6 is an explanatory diagram for describing a converting circuit capable of adjusting a gain according to the present embodiment.

FIG. 7 is a block diagram showing one example of a constitution of an imaging device according to the second embodiment.

FIG. 8 is a block diagram showing one example of a schematic configuration of a vehicle control system.

FIG. 9 is a diagram showing one example of an installation position of a vehicle outside information detecting section and an imaging section.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, hereinafter, description is given in the order shown in the below.

1. Imaging device according to first embodiment

2. Imaging device according to second embodiment

3. Application example of imaging device according to present embodiment

4. Program according to present embodiment

### Imaging Device According to First Embodiment

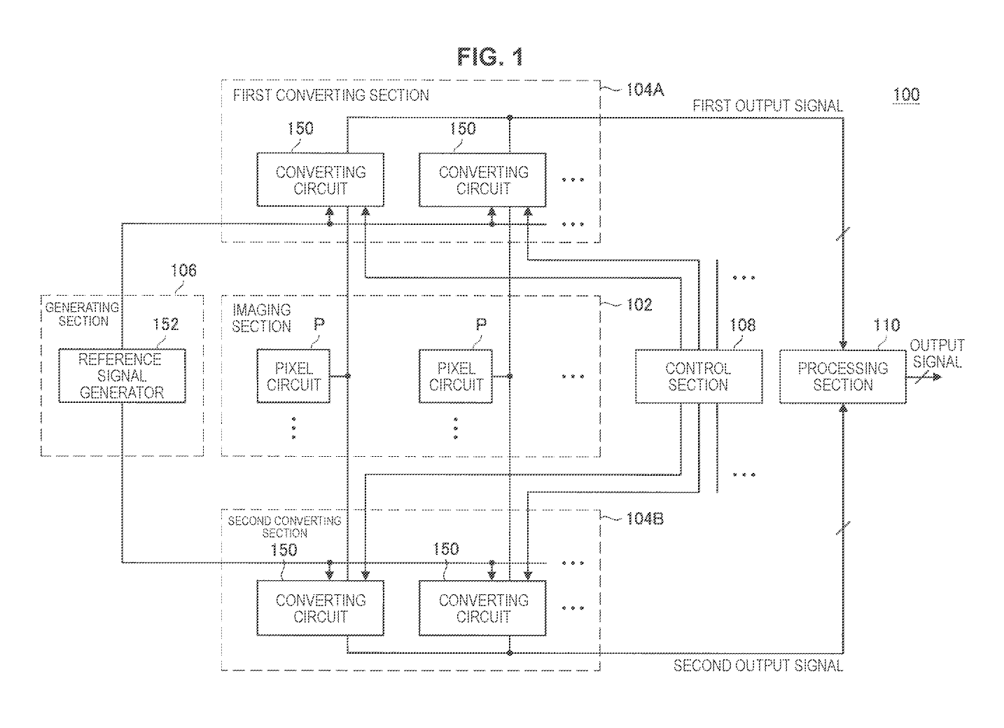

FIG. 1 is a block diagram showing one example of a constitution of an imaging device 100 according to the first embodiment. In FIG. 1, a part of hardware that constitutes the imaging device 100 is illustrated for convenience of illustration.

The imaging device 100 includes, for example, an imaging section 102, a first converting section 104A, a second converting section 104B, a generating section 106, a control section 108, and a processing section 110. The imaging device 100 is driven by electric power supplied from an internal electrical power source such as a battery or electric power supplied from an external electrical power source.

### (1) Imaging Section 102

The imaging section 102 includes a plurality of pixel circuits P that perform photoelectric conversion. The pixel circuit P that constitutes the imaging section 102 outputs analog signals (hereafter, merely denoted as “analog signals”) corresponding to incident light.

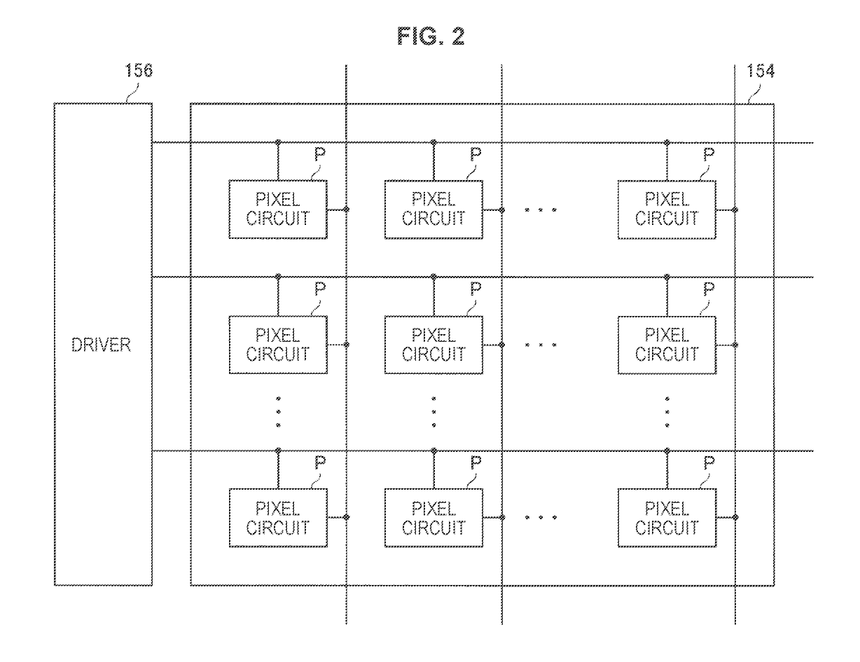

FIG. 2 is an explanatory diagram for describing one example of a hardware constitution of the imaging section 102 equipped in the imaging device 100 according to the first embodiment, and shows a part of the hardware constitution of the imaging section 102.

The imaging section 102 includes, for example, a lens (not shown) of an optical system, an image sensor (not shown), a pixel array 154 corresponding to the image sensor (not shown), and a driver 156.

As the image sensor (not shown) according to the present embodiment, for example, a CMOS (Complementary Metal Oxide Semiconductor) and a CCD (Charge Coupled Device) are cited. Moreover, the image sensor (not shown) according to the present embodiment may be a stacked type image sensor in which other components, such as a CCD, are stacked on the CMOS. That is, it is possible to apply a global shutter system and a rolling shutter system to the imaging device according to the present embodiment equipped with the imaging section 102.

In the pixel array 154, a plurality of pixel circuits P are arranged in a matrix form, and each of the pixel circuits P is electrically connected with the driver 156 via signal lines. The pixel circuit P includes, for example, a light receiving element, such as a photo diode, a transistor, a capacitive element, and so on. In the pixel circuit P, by control signals transmitted from the driver 156 via signal lines, accumulation of signal electric charges corresponding to incident light, initialization of the pixel circuit P, and so on are performed.

As the above-described transistor that constitutes the pixel circuit P, for example, a bipolar transistor, FET (Field-Effect Transistor), such as TFT (Thin Film Transistor) and MOSFET (Metal-Oxide-Semiconductor Field Effect Transistor), and so on are cited. Moreover, as the above-described capacitive element that constitutes the pixel circuit P, for example, a capacitor is cited. In this connection, in the above-described capacitive element that constitutes the pixel circuit P, parasitic capacitance, such as wiring, may be included.

The driver 156 drives the pixel circuit P by transmitting control signals to the pixel circuit P.

For example, by including the constitution having been described with reference to FIG. 2, analog signals by photoelectric conversion in the pixel circuit P are output from the imaging section 102. In this connection, it goes without saying that the constitution of the imaging section 102 is not limited to the constitution having been described with reference to FIG. 2.

### (2) First Converting Section 104A, Second Converting Section 104B

The first converting section 104A converts analog signals output from the pixel circuit P that constitutes the imaging section 102, into digital signals. The first converting section 104A includes a converting circuit 150 that converts analog signals into digital signals, and converts analog signal output from the pixel circuit P into digital signals by the converting circuit 150.

As the converting circuit 150 that constitutes the first converting section 104A, for example, an analog-to-digital converting circuit in which a gain of analog signal to be converted into digital signal is being fixed, is cited. As the above-described analog-to-digital converting circuit, for example, an arbitrary type analog-to-digital converting circuit, such as a successive comparison type analog-to-digital converting circuit, is cited.

Moreover, the converting circuit 150 that constitutes the first converting section 104A may have a constitution capable of adjusting a gain of analog signals to be converted into digital signals (constitution capable of switching a gain of analog signals).

The converting circuit 150 capable of adjusting a gain according to the present embodiment includes a comparator. Then, in the converting circuit 150 capable of adjusting a gain according to the present embodiment, a gain is adjusted by switching a capacitance ratio of a capacitance connected to a terminal to be applied with a reference signal and a capacitance connected to a terminal to be electrically connected to the pixel circuit P in a comparator. One example of a constitution of the converting circuit 150 capable of adjusting a gain according to the present embodiment is mentioned later.

The second converting section 104B converts analog signals output from the pixel circuit P that constitutes the imaging section 102, into digital signals. The second converting section 104B includes a converting circuit 150 that converts analog signals into digital signals, and converts analog signal output from the pixel circuit P into digital signals by the converting circuit 150.

As the converting circuit 150 that constitutes the second converting section 104B, for example, an analog-to-digital converting circuit in which a gain of analog signal to be converted into digital signal is being fixed, is cited. As the above-described analog-to-digital converting circuit, for example, an arbitrary type analog-to-digital converting circuit, such as a successive comparison type analog-to-digital converting circuit, is cited.

Moreover, the converting circuit 150 that constitutes the second converting section 104B may be a constitution capable of adjusting a gain of analog signals to be converted into digital signals. As described in the above, the converting circuit 150 capable of adjusting a gain according to the present embodiment includes a comparator, and a gain is adjusted by switching a capacitance ratio of capacitances connected to terminals of the comparator. One example of a constitution of the converting circuit 150 capable of adjusting a gain according to the present embodiment is mentioned later.

The first converting section 104A and the second converting section 104B have, for example, the features of the following (a) to (c).

### (a) First Feature

It is possible for the first converting section 104A and the second converting section 104B to convert analog signals output from the same pixel circuit P that constitutes the imaging section 102, into digital signals.

For example, in the imaging device 100 shown in FIG. 1, the first converting section 104A includes the conversion circuits 150 of the same number as the number of columns in the pixel array 154 of the imaging section 102, and the converting circuit 150 which constitutes the first converting section 104A is electrically connected to the pixel circuit P on a corresponding column in the pixel array 154 via a signal line. Moreover, for example, in the imaging device 100 shown in FIG. 1, the second converting section 104B includes the conversion circuits 150 of the same number as the number of columns in the pixel array 154 of the imaging section 102, and the converting circuit 150 which constitutes the second converting section 104B is electrically connected to the pixel circuit P on a corresponding column in the pixel array 154 via a signal line.

Since the first converting section 104A and the second converting section 104B include the constitution as shown in FIG. 1, the imaging device 100 includes “a constitution in which the first converting section 104A and the second converting section 104B convert analog signals output from the same pixel circuit P that constitutes the imaging section 102, into digital signals”.

### (b) Second Feature

The same reference signal (voltage signal) is supplied to the first converting section 104A and the second converting section 104B.

For example, in the imaging device 100 shown in FIG. 1, each of the converting circuits 150 that constitute the first converting section 104A is electrically connected to a reference signal generator 152 that constitutes the generating section 106, via signal lines. Moreover, for example, in the imaging device 100 shown in FIG. 1, each of the converting circuits 150 that constitute the second converting section 104B is electrically connected to the reference signal generator 152 that constitutes the generating section 106, via signal lines.

Since the first converting section 104A and the second converting section 104B have the constitution as shown in FIG. 1, the same reference signal used for analog-to-digital conversion is supplied from the reference signal generator 152 to each of the converting circuits 150 that constitute the first converting section 104A and the second converting section 104B.

Here, for example, the layout of the first converting section 104A, the second converting section 104B, and the reference signal generator 152, has symmetry. In concrete terms, for example, “a position at which the reference signal generator 152 is disposed relative to the first converting section 104A and a wiring that connects the reference signal generator 152 and the first converting section 104A” and “the position at which the reference signal generator 152 is disposed relative to the second converting section 104B and the wiring that connects the reference signal generator 152 and the second converting section 154B” have symmetry. In this connection, as mentioned later, the reference signal generator 152 may be an external device of the imaging device 100.

As described in the above, in the case where the first converting section 104A, the second converting section 104B, and the reference signal generator 152 have a layout with symmetry, “a deviation between a reference signal supplied to the converting circuit 150 included in the first converting section 104A and a reference signal supplied to the converting circuit 150 that is connected to the same pixel circuit P as that connected to the above converting circuit 150 and is included in the second converting section 104B” can be made smaller. Therefore, as described in the above, in the case where the first converting section 104A, the second converting section 104B, and the reference signal generator 152 have a layout with symmetry, it is possible to further attempt to make the image quality of a captured image obtained by the imaging higher.

Moreover, the wiring that connects the reference signal generator 152 and the first converting section 104A and the wiring that connects the reference signal generator 152 and the second converting section 104B are not limited to have symmetry. In the imaging device 100, for example, wiring to be connected to both of the first converting section 104A and the second converting section 154B, such as grounding wire and power source lines, also may have symmetry.

In this connection, it goes without saying that, in the imaging device 100, it is possible for the first converting section 104A, the second converting section 104B, and the reference signal generator 152 to take a constitution not having a layout with strict symmetry.

### (c) Third Feature

One or both of the first converting section 104A and the second converting section 104B has or have a constitution capable of adjusting a gain of analog signals to be converted into digital signals.

Here, as shown in the above (b), the same reference signal is supplied to the first converting section 104A and the second converting section 104B. That is, the imaging device 100 according to the first embodiment has not a constitution that converts analog signals into digital signals by respective reference signals different from each other, for example, as in the technology described in Patent Literature 1.

As described in the above, the converting circuit 150 included in the first converting section 104A capable of adjusting a gain and the converting circuit 150 included in the second converting section 104B capable of adjusting a gain, include a comparator, and a gain is adjusted by switching a capacitance ratio of capacitances connected to terminals of the comparator.

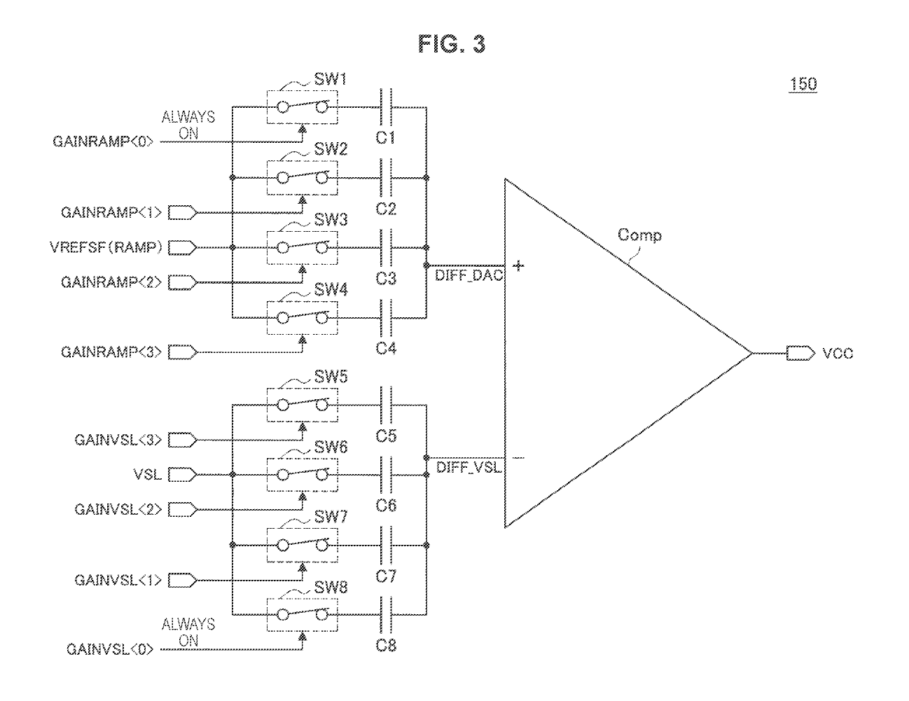

FIG. 3 is an explanatory diagram for describing the converting circuit 150 capable of adjusting a gain according to the present embodiment, and shows a constitution related to adjustment of a gain among the constitution of the converting circuit 150, i.e., a part of the constitution of the converting circuit 150.

The converting circuit 150 capable of adjusting a gain includes a comparator Comp. A non-inverting input terminal (+) of the comparator Comp is electrically connected to the reference signal generator 152, and is applied with reference signals. Moreover, an inverting input terminal (−) of the comparator Comp is electrically connected to the pixel circuit P, and is applied with analog signals.

Moreover, the converting circuit 150 capable of adjusting a gain includes, for example, a counter circuit (not shown) at a latter stage of the comparator Comp. The counter circuit (not shown) equipped in the converting circuit 150 capable of adjusting a gain, for example, is provided with counter clocks and a count direction by control signals transmitted from a later-mentioned control section 108, and performs a count operation. Moreover, in the counter circuit (not shown) equipped in the converting circuit 150 capable of adjusting a gain, a count is reset by control signals transmitted from the later-mentioned control section 108. The counter circuit (not shown) outputs digital signals corresponding to the signal levels of analog signals input into the comparator Comp.

Therefore, the converting circuit 150 capable of adjusting a gain can convert analog signals into digital signals.

In this connection, the constitution of the converting circuit 150 capable of adjusting a gain is not limited to the example shown in the above. For example, the converting circuit 150 capable of adjusting a gain may have a constitution that includes a buffer at a latter stage of the counter circuit (not shown).

Hereinafter, while referring to FIG. 3, one example of a constitution related to adjustment of a gain among the constitutions of the converting circuit 150 is described.

To the non-inverting input terminal (+) of the comparator Comp, connected are a plurality of capacitive elements C1, C2, C3, and C4 and switching circuits SW1, SW2, SW3, and SW4 for changing a capacitance to be connected the non-inverting input terminal (+) of the comparator Comp. In this connection, the number of the capacitive elements and switching circuits to be connected to the non-inverting input terminal (+) of the comparator Comp is not limited to the example shown in FIG. 3.

As the capacitive elements C1, C2, C3, and C4, for example, a capacitor is cited. Moreover, the capacitance of each of the capacitive elements C1, C2, C3, and C4 may be the same, or at least some of them may be different.

Each of the switching circuits SW1, SW2, SW3, and SW4, for example, becomes an ON state (conduction state) or an OFF state (non-conduction state) by a corresponding one signal of control signals GAINRAMP<0>, GAINRAMP<1>, GAINRAMP<2> and GAINRAMP<3> transmitted from the later-mentioned control section 108. In the case where one or two or more of the switching circuits SW1, SW2, SW3, and SW4 becomes or become in an ON state, the capacitive element(s) connected to the switching circuit(s) having become the ON state among the capacitive elements C1, C2, C3, and C4, is or are made a state of having been connected electrically to the non-inverting input terminal (+) of the comparator Comp.

As the switching circuits SW1, SW2, SW3, and SW4, for example, a switching transistor is cited. As the switching transistor, for example, a bipolar transistor and a FET, such as, a TFT, and a MOSFET, are cited.

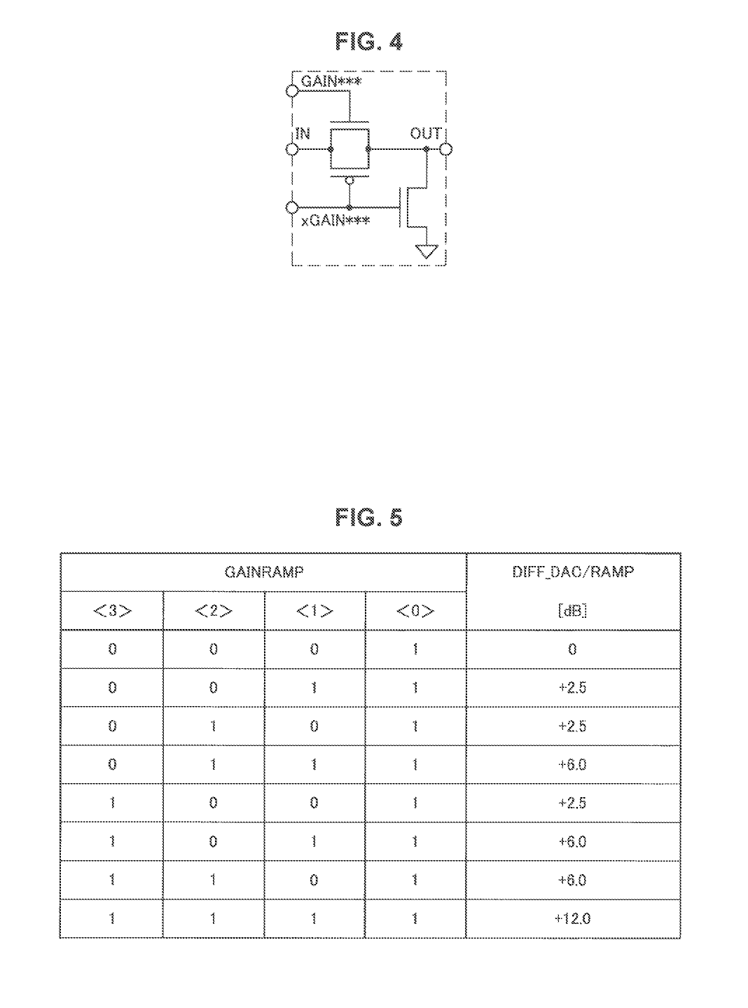

In this connection, the switching circuits SW1, SW2, SW3, and SW4 may be an arbitrary element or a circuit including a plurality of elements, in which an ON state and an OFF state can be switched over. FIG. 4 is an explanatory diagram showing one example of a switching circuit according to the present embodiment, and shows one example of a switching circuit including a plurality of elements.

Again, with reference to FIG. 3, a constitution related to adjustment of a gain among the constitutions of the converting circuit 150 is described. To the inverting input terminal (−) of the comparator Comp, connected are a plurality of capacitive elements C5, C6, C7, and C8 and switching circuits SW5, SW6, SW7, and SW8 for changing a capacitance to be connected to the inverting input terminal (−) of the comparator Comp. In this connection, the number of the capacitive elements and switching circuits to be connected to the inverting input terminal (−) of the comparator Comp is not limited to the example shown in FIG. 3.

As the capacitive elements C5, C6, C7, and C8, for example, a capacitor is cited. Moreover, the capacitance of each of the capacitive elements C5, C6, C7, and C8 may be the same, or at least some of them may be different. Moreover, the capacitive elements C1, C2, C3, and C4 and the capacitive elements C5, C6, C7, and C8 may be the same, or at least some of them may be different.

Each of the switching circuits SW5, SW6, SW7, and SW8, for example, becomes an ON state or an OFF state by a corresponding one signal of control signals GAINVSL<0>, GAINVSL<1>, GAINVSL<2> and GAINVSL<3> transmitted from the later-mentioned control section 108. In the case where one or two or more of the switching circuits SW5, SW6, SW7, and SW8 becomes or become in an ON state, the capacitive element(s) connected to the switching circuit(s) having become the ON state among the capacitive elements C5, C6, C7, and C8, is or are made a state of having been connected electrically to the inverting input terminal (−) of the comparator Comp.

As the switching circuits SW5, SW6, SW7, and SW8, for example, a switching transistor is cited. Moreover, the switching circuit SW5, SW6, SW7, and SW8 may be an arbitrary element or a circuit including a plurality of elements as shown in FIG. 4, in which an ON state and an OFF state can be switched over.

Since the converting circuit 150 capable of adjusting a gain has a constitution, for example, as shown in FIG. 3, it is possible to switch a capacitance ratio of a capacitance to be connected to a terminal (non-inverting input terminal (+)) to be applied with a reference signal and a capacitance to be connected to a terminal (inverting input terminal (−)) to be electrically connected to the pixel circuit P in the comparator Comp.

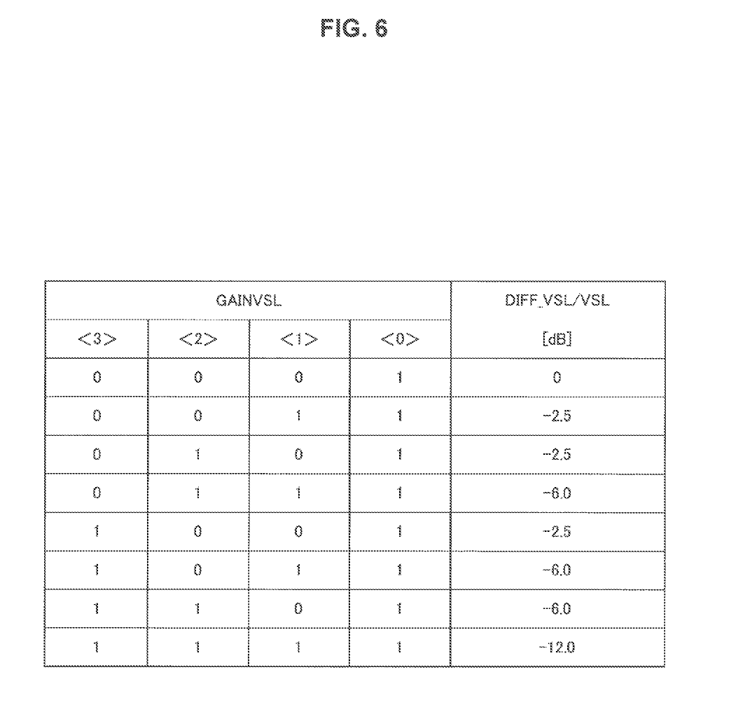

FIG. 5 and FIG. 6 are explanatory diagrams for describing the converting circuit 150 capable of adjusting a gain according to the present embodiment, and show one example of adjustment of a gain in the converting circuit 150 capable of adjusting a gain. FIG. 5 and FIG. 6 show an example in which capacitive elements C1, C2, C3, and C4 and capacitive elements C5, C6, C7, and C8 that constitute the converting circuit 150 capable of adjusting a gain, are 96.74 [fF].

In the converting circuit 150 capable of adjusting a gain, a gain is adjusted by switching a capacitance ratio of capacitances to be connected to the terminals (the non-inverting input terminal (+) and the inverting input terminal (−)) of the comparator Comp.

The first converting section 104A and the second converting section 104B, for example, have the features of the above-described (a) to (c). Since the first converting section 104A and the second converting section 104B have the features of the above-described (a) to (c), the imaging device 100 attains the effect that it is possible to attempt to make image quality higher as shown in the below.
It is possible to read out analog signals acquired from the same pixel circuit P simultaneously with the same gain or different gains.
In the case of reading out with the same gain, since noise can be reduced, it is possible to attempt to make image quality higher.
In the case of reading out with different gains, by performing a pseudo bit expanding process (pseudo multi-bit making process) and HDR in the later-mentioned processing section 110 or an external processing circuit, it is possible to attempt to make image quality higher. As one example in which analog signals acquired from the same pixel circuit P are read out with different gains, for example, cited is “an example in which, among the converting circuit 150 equipped in the first converting section 104A and the converting circuits 150 equipped in the second converting section 104B that are connected to the same pixel circuit P, one of the converting circuits 150 reads out with a low gain (for example, 0 [dB] etc.) so as to make an amount of saturation signals larger, and the other of the converting circuits 150 reads out with a high gain (for example, 6 [dB], 12 [dB], 24 [dB], etc.) so as to make noise smaller”.

With regard to digital signals (hereafter, may be denoted as “the first output signal”) output from the first converting section 104A, the output is controlled by a driver (not shown) corresponding to the first converting section 104A. Moreover, with regard to digital signals (hereafter, may be denoted as “the second output signal”) output from the second converting section 104B, the output is controlled by a driver (not shown) corresponding to the second converting section 104B. The driver (not shown) corresponding to the first converting section 104A and the driver (not shown) corresponding to the second converting section 104B, for example, are controlled by a timing controller (not shown) equipped in the control section 108 or the imaging device 100.

In the case of citing one example, the driver (not shown) corresponding to the first converting section 104A and the driver (not shown) corresponding to the second converting section 104B, for example, control the output such that the first output signal and the second output signal are output alternately for each row in the pixel array 154 of the imaging section 102. In the case where the first output signal and the second output signal are output alternately for each row in the pixel array 154 of the imaging section 102, for example, data indicating a fact of being output alternately are stored in a header portion, whereby the contents of signals being output are discriminated. In this connection, it goes without saying that the example of the output of the first output signal and the second output signal is not limited to the example shown in the above.

Moreover, in the imaging device 100, for example, in the first converting section 104A and the second converting section 104B, digital clamp is performed individually.

### (3) Generating Section 106

The generating section 106 includes a reference signal generator 152, and generates and outputs reference signals. As the reference signal generator 152, arbitrary hardware that functions as a signal source of reference signals, is cited.

In this connection, in the case where the imaging device 100 uses reference signals generated in an external reference signal generator, the imaging device 100 may not include the generating section 106. That is, the reference signal generator 152 shown in FIG. 1 may be a signal source equipped in the imaging device 100, or may be a signal source in the outside of the imaging device 100.

### (4) Control Section 108

The control section 108 includes, for example, one or two or more processors including arithmetic circuits, such as an MPU (Micro Processing Unit), various processing circuits, and so on, and achieves a role that controls the whole imaging device 100.

Moreover, the control section 108 performs the control of a gain in the first converting section 104A capable of adjusting a gain and the control of a gain in the second converting section 104B capable of adjusting a gain.

As the control of a gain in the first converting section 104A capable of adjusting a gain, cited is the transmitting of control signals to the converting circuit 150 that constitutes the first converting section 104A and is able to adjust a gain. Moreover, as the control of a gain in the second converting section 104B capable of adjusting a gain, cited is the transmitting of control signals to the converting circuit 150 that constitutes the second converting section 104B and is able to adjust a gain. As the control signals to be transmitted to the converting circuit 150, for example, cited are the control signals GAINRAMP<0>, GAINRAMP<1>, GAINRAMP <2>, and GAINRAMP<3> shown in FIG. 3 and the control signals GAINVSL<0>, GAINVSL<1>, GAINVSL<2>, and GAINVSL<3> shown in FIG. 3.

### [4-1] One Example of Processes in Control Section 108: One Example of Processes Related to Control Method According to First Embodiment

The control section 108, for example, controls a gain on the basis of operation signals corresponding to an operation of a user relative to an operation device. As the operation device according to the present embodiment, for example, cited is an operation device equipped in the imaging devices 100, such as a button, or, an external operation device, such as a remote controller (or, an external device that functions as a remote controller).

The control section 108, for example, performs the control of a gain corresponding to an operation signal by referring to a table (or data base) in which ID showing an operation and the contents of the control of a gain are associated with each other. The above-described table in which ID showing an operation and the contents of the control of a gain are associated with each other, for example is memorized in a recording medium equipped in the imaging device 100 or an external recording medium connected to the imaging device 100 (in this connection, this matter is similarly applied to the other tables mentioned later).

In this connection, the example of the control of a gain in the control section 108 is not limited to the example shown in the above.

For example, the control section 108 may perform the control of a gain on the basis of a state of the imaging device 100. As the state of the imaging device 100, for example, cited is a state of an application being executed in a processor etc. that constitute the control section 108 in the imaging device 100, a state of processing in the later-mentioned processing section 110, or a combination of these. By performing the control of a gain on the basis of the detection result of the state of the imaging device 100, the dynamic control of a gain based on the state of the imaging device 100 is realized.

The control section 108, for example, performs the above-described dynamic control of a gain by referring to a table (or data base) in which the state of the imaging device 100, such as a state of an application, and the control contents of the gain are associated with each other.

### (5) Processing Section 110

The processing section 110 includes various processing circuits etc., and processes the first output signal and the second output signal. In this connection, the processing circuit that constitutes the processing section 110 may be a processing circuit that constitutes the control section 108.

As the process in the processing section 110, a process of synthesizing the first output signal and the second output signal, is cited.

For example, in the case where analog signals acquired from the same pixel circuit P are read out simultaneously with the same gain by the first converting section 104A and the second converting section 104B, the processing section 110 synthesizes the first output signal and the second output signal for each corresponding pixel. Therefore, reduction of noise that may be included in a captured image is realized.

Moreover, for example, in the case where analog signals acquired from the same pixel circuit P are read out simultaneously with different gains by the first converting section 104A and the second converting section 104B, the processing section 110 performs processes as shown in the below.
Pseudo bit expanding process (pseudo multi-bit making process): for example, a process of increasing the number of bits in a pseudo manner by performing bit shift for signals on a low gain side and by interpolating low-order bits with signals on a high gain side
HDR: for example, a process of synthesizing a low gain portion on a high illuminance side of a captured image and a high gain portion on a low illuminance side of the captured image
Pseudo bit expanding process (pseudo multi-bit making process) and HDR

In this connection, it goes without saying that the processes in the processing section 110 are not limited to the example shown in the above.

In FIG. 1, digital signals synthesized by the processing section 110 are denoted as “output signal”. The output signals output from the processing section 110, for example, are memorized in the recording medium equipped in the imaging device 100 or an external recording medium connected to the imaging device 100. Moreover, the output signals output from the processing section 110, for example, may be transmitted to an external device by a communication device of an arbitrary communication system equipped in the imaging device 100, or an external communication device connected to the imaging device 100. As the external device to which the output signals are transmitted, for example, cited are arbitrary devices, such as a display device capable of displaying a captured image on a display screen and computers, such as a PC (Personal Computer) and a server.

The imaging device 100 according to the first embodiment, for example, includes a constitution shown in FIG. 1.

The imaging device 100 includes the first converting section 104A and the second converting section 104B that have the features of the above-described (a) to (c). Therefore, the imaging device 100 can attempt to make the image quality of a captured image obtained by imaging, higher.

In this connection, the constitution of the imaging device according to the first embodiment is not limited to the example shown in FIG. 1.

For example, in the case where reference signals generated in an external reference signal generator are used, the imaging device according to the first embodiment may not include the generating section 106 shown FIG. 1.

Moreover, in the case where the control of a gain is performed by an external device (or, external processor etc.) that includes the function similar to that of the control section 108, the imaging device according to the first embodiment may not include the control section 108 shown in FIG. 1.

Moreover, in the case where the process based on the first output signal and the second output signal is performed by an external devices (or, external processing circuit etc.) that includes the function similar to that of the processing section 110, the imaging device according to the first embodiment may not include the processing section 110 shown in FIG. 1.

In this connection, the constitution of the imaging device according to the present embodiment is not limited to the imaging device (including also a modified example) according to the first embodiment shown in FIG. 1. Next, as the other constitution example of the imaging device according to the present embodiment, an imaging device according to the second embodiment is described.

### Imaging Device According to Second Embodiment

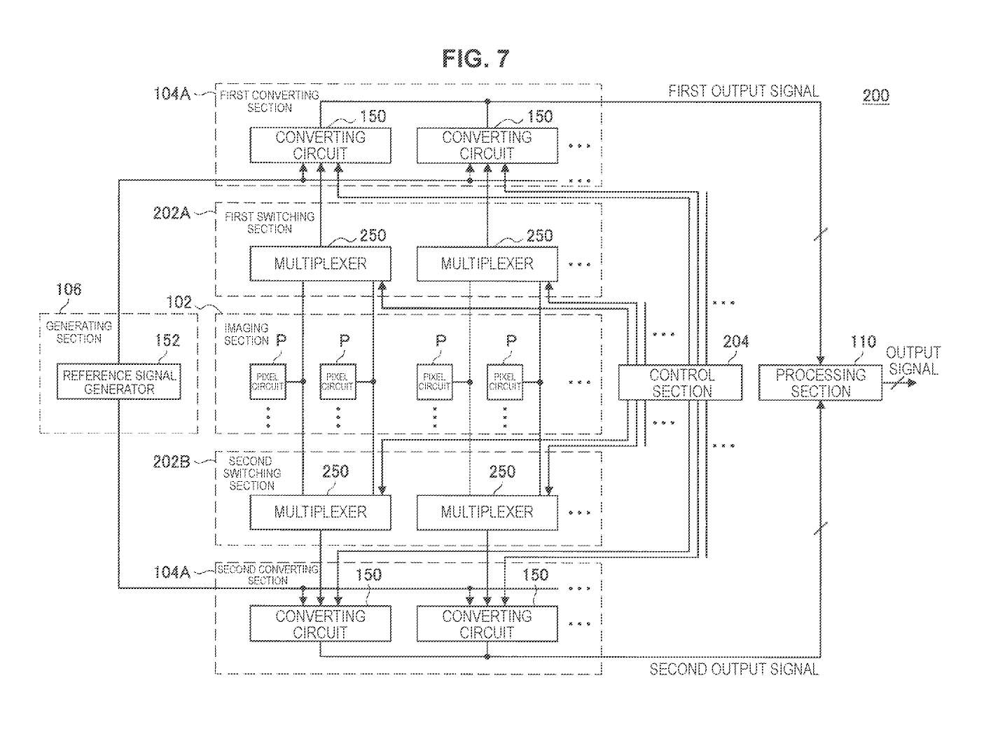

FIG. 7 is a block diagram showing one example of a constitution of an imaging device 200 according to the second embodiment. In FIG. 7, similarly to FIG. 1, a part of hardware that constitutes the imaging device 200 is illustrated for convenience of illustration.

The imaging device 100, for example, includes an imaging section 102, a first converting section 104A, a second converting section 104B, a generating section 106, a processing section 110, a first switching section 202A, a second switching section 202B, and a control section 204. The imaging device 200 is driven by electric power supplied from an internal electrical power source, such as a battery or electric power supplied from an external electrical power source.

### [I] Imaging Section 102, First Converting Section 104A, Second Converting Section 104B, Generating Section 106, Processing Section 110

The constitution and function of each of the imaging section 102, the first converting section 104A, the second converting section 104B, the generating section 106, and the processing section 110 according to the second embodiment shown in FIG. 7 are similar to those of each of the imaging section 102, the first converting section 104A, the second converting section 104B, the generating section 106, and the processing section 110 according to the first embodiment shown with reference to FIG. 1. Therefore, with regard to the imaging section 102, the first converting section 104A, the second converting section 104B, the generating section 106, and the processing section 110 according to the second embodiment shown in FIG. 7, description is omitted.

### [II] First Switching Section 202A, Second Switching Section 202B

The first switching section 202A is electrically connected between the imaging section 102 and the first converting section 104A, and switches the pixel circuits P to be electrically connected to the first converting section 104A.

The first switching section 202A, for example, includes multiplexers 250 corresponding to the converting circuits 150 that constitute the first converting section 104A. In the first switching section 202A, by switching the outputs in the multiplexers 250, the pixel circuit P to be electrically connected to the first converting section 104A is switched. In this connection, FIG. 7 shows an example in which the multiplexer 250 is a multiplexer of two input and one output. However, it goes without saying that the number of inputs of the multiplexer 250 may be three or more.

The switching of the output in the multiplexer 250, for example, is performed by a control signal transmitted from the later-mentioned control section 204.

The second switching section 202B, for example, includes multiplexers 250 corresponding to the converting circuits 150 that constitute the second converting section 104B. In the second switching section 202B, by switching the outputs in the multiplexers 250, the pixel circuit P to be electrically connected to the second converting section 104B is switched. In this connection, FIG. 7 shows an example in which the multiplexer 250 is a multiplexer of two input and one output. However, it goes without saying that the number of inputs of the multiplexer 250 may be three or more.

By including the first switching section 202A and the second switching section 202B, in the imaging device 200, in the first converting section 104A and the second converting section 104B, “analog signals output from the same pixel circuit P that constitutes the imaging section 102”, or “analog signals output from the different pixel circuits P which constitute the imaging section 102” are converted into digital signals. That is, in the imaging device 200 according to the second embodiment, in addition to the feature shown in the above (a), the first converting section 104A and the second converting section 104B according to the second embodiment become to have the feature that “it is possible to convert analog signals output from the different pixel circuits P that constitute the imaging section 102, into digital signals”.

### [III] Control Section 204

The control section 204 includes, for example, one or two or more processors including arithmetic circuits, such as an MPU (Micro Processing Unit), various processing circuits, and so on, and achieves a role that controls the whole imaging device 200.

Moreover, the control section 204 performs the control of a gain in the first converting section 104A capable of adjusting a gain, the control of a gain in the second converting section 104B capable of adjusting a gain, and the control of switching of connection in the first switching section 202A and the second switching section 202B.

As the control of a gain in the first converting section 104A capable of adjusting a gain, similarly to the control of a gain according to the first embodiment, cited is the transmitting of control signals to the converting circuit 150 that constitutes the first converting section 104A and is able to adjust a gain. Moreover, as the control of a gain in the second converting section 104B capable of adjusting a gain, similarly to the control of a gain according to the first embodiment, cited is the transmitting of control signals to the converting circuit 150 that constitutes the second converting section 104B and is able to adjust a gain.

As the control of switching of the connection in the first switching section 202A, for example, cited is the transmitting of control signals to the multiplexer 250 that constitutes the first switching section 202A. As the control of switching of the connection in the second switching section 202B, for example, cited is the transmitting of control signals to the multiplexer 250 that constitutes the second switching section 202B. The control signal to be transmitted to the multiplexer 250 corresponds to a signal that selects which signal to be output from a plurality of input signals.

### [III-I] One Example of Processes in Control Section 204: One Example of Processes Related to Control Method According to Second Embodiment

The control section 204 performs, for example, the control of a gain and the control of switching of connection on the basis of an operation signal corresponding to an operation of a user to an operation device.

The control section 204, for example, performs the control of a gain corresponding to an operation signal and the control of switching of connection corresponding to an operation signal by referring to a table (or data base) in which ID showing an operation, the contents of the control of a gain, and the contents of the switching of connection are associated with each other.

In this connection, the example of the control of a gain and the control of switching of connection in the control section 204 is not limited to the example shown in the above.

For example, the control section 204 may perform the control a gain and the control of switching of connection on the basis of a state of the imaging device 200. As the states of the imaging device 200, for example, cited is a state of electric power consumption detected on the basis of a value of electric power (for example, a value of maximum electric power consumption, an average value of electric power consumption in a set period, etc.) being consumed in the imaging device 200, a state of an application being executed in a processor etc. that constitute the control section 204 in the imaging device 100, a state of processing in the later-mentioned processing section 110, or a combination of two or more of these. By performing the control of a gain and the control of switching of connection on the basis of the detection result of the state of the imaging device 200, the dynamic control of a gain and the dynamic control of switching of connection based on the state of the imaging device 200 are realized.

The control section 108, for example, performs the above-described dynamic control of a gain and the above-described dynamic control of switching of connection by referring to a table (or data base) in which the state of the imaging device 200, such as the state of an application, the contents of the control of a gain, and the contents of the control of switching of connection are associated with each other.

By performing the control of a gain and the control of switching of connection in the control section 204, for example, the switching of modes, as shown in following (A) to (C) is realized in the imaging device 200. In this connection, it goes without saying that the example of switching of modes realized in the imaging device 200 according to the second embodiment is not limited to the example shown in the following (A) to (C).

### (A) First Example of Switching of Modes: Switching of Imaging Speed

In the first example of switching of modes, a high image quality mode to acquire a high quality captured image and a mode to perform high-speed imaging (mode to perform high-speed reading-out) are switched.

In the high image quality mode, the first converting section 104A and the second converting section 104B convert analog signals output from the same pixel circuit P that constitutes the imaging section 102, into digital signals. Accordingly, in the high image quality mode, the making the image quality of a captured image higher is attained by processes in the processing section 110 and by enlarging a dynamic range by HDR, expanding bits by a pseudo bit expanding process (pseudo multi-bit making process), adjusting a white gain, reducing noise, and the like.

Moreover, in the mode to perform high-speed imaging, the first converting section 104A and the second converting section 104B convert analog signals output from the different pixel circuits P that constitute the imaging section 102, into digital signals. Accordingly, in the mode to perform high-speed imaging, since double-speed imaging becomes possible as compared with the high image quality mode, more high-speed imaging becomes possible. The mode to perform high-speed imaging, for example, may be applied to a slow motion imaging use.

### (B) Second Example of Switching of Modes: Switching of Electric Power Consumption of Imaging Device 200

In the second example of switching of modes, a high image quality mode to acquire a high quality captured image and a low electric power consumption mode to reduce electric power consumption are switched.

In the high image quality mode, similarly to the first example shown in the above-described (A), the first converting section 104A and the second converting section 104B convert analog signals output from the same pixel circuit P that constitutes the imaging section 102, into digital signals. Accordingly, in the high image quality mode, the making the image quality of a captured image higher is attained.

In the low electric power consumption mode, only the converting circuit 150 that constitutes one of the first converting section 104A and the second converting section 104B that are connected to the same pixel circuit P, operates, and converts analog signals output from the pixel circuit P into digital signals. At this time, the converting circuit 150 that constitutes the other of the first converting section 104A and the second converting section 104B that are connected to the same pixel circuit P, does not operate. Therefore, in the low electric power consumption mode, since the number of the converting circuits 150 that operate in the imaging device 200 is reduced, electric power consumption is reduced. Moreover, in the case where the imaging device 200 is driven by an internal electrical power source such as a battery etc., in the low electric power consumption mode, it becomes possible to prolong the time that makes it possible to perform imaging, than the high image quality mode.

### (C) Third Example of Switching of Modes: Switching of Imaging Quality

In the third example of switching of modes, a first mode that converts analog signals into digital signals with set first resolving power and a second mode that acquires digital signals of resolving power higher than the first resolving power, are switched.

In the first mode, the first converting section 104A and the second converting section 104B convert analog signals output from the different pixel circuits P that constitute the imaging section 102, into digital signals.

Moreover, in the second mode, the first converting section 104A and the second converting section 104B convert analog signals output from the same pixel circuit P that constitutes the imaging section 102, into digital signals. Accordingly, in the second mode, by expanding bits by a pseudo bit expanding process (pseudo multi-bit making process) in the processing section 110, digital signals with resolving power higher than the first resolving power in the first mode are acquired. The second mode may be applied, for example, to a use in which an object of an inspection target based on a captured image is captured. Moreover, in the first mode and the second mode, since the data formats of the first output signal and the second output signal are the same, it becomes possible to switch modes in the middle of imaging.

The imaging device 200 according to the second embodiment includes, for example, the constitution shown in FIG. 7.

Similarly to the imaging device 100 according to the first embodiment shown in FIG. 1, the imaging device 200 includes the first converting section 104A and the second converting section 104B that have the features of the above-described (a) to (c). Therefore, similarly to the imaging device 100 according to the first embodiment, the imaging device 200 can attain making the image quality of a captured image obtained by imaging higher.

Moreover, by including the first switching section 202A and the second switching section 202B, the imaging device 200 can switch the pixel circuit P to be electrically connected to the first converting section 104A and the pixel circuit P to be electrically connected to the second switching section 202B. Therefore, in the imaging device 200, for example, since it is possible to realize the switching of the modes as shown in the above-described (A) to (C), the effects corresponding to the mode to be set is exerted.

In this connection, the constitution of the imaging device according to the second embodiment is not limited to the example shown in FIG. 7.

For example, in the case where reference signals generated in an external reference signal generator are used, the imaging device according to the second embodiment may not include the generating section 106 shown FIG. 7.

Moreover, in the case where the control of a gain is performed by an external device (or, external processor etc.) that includes the function similar to that of the control section 204, the imaging device according to the second embodiment may not include the control section 204 shown in FIG. 7.

Moreover, in the case where the process based on the first output signal and the second output signal is performed by an external devices (or, external processing circuit etc.) that includes the function similar to that of the processing section 110, the imaging device according to the second embodiment may not include the processing section 110 shown in FIG. 7.

### Application Example of Imaging Device According to Present Embodiment

As the present embodiment, although the description has been given by citing the imaging device, the present embodiment is not limited to such a mode. The present embodiment can be applied to, for example, cameras (digital still camera, digital video camera) used for various applications, such as industrial cameras used in a factory, a physical distribution system, etc., cameras used in an ITS (Intelligent Transport Systems), security cameras, cameras disposed in movable objects such as a car, and cameras oriented for consumers. Moreover, the present embodiment can be applied to various devices capable of including an imaging device, such as, computers, such as PC, communication devices, such as a smart phone, tablet type device, and a game machine.

Furthermore, it is possible for the imaging device according to the present embodiment to be applied to, for example, arbitrary movable objects, such as a car, an electric vehicle, a hybrid electric vehicle, a motorcycle, a bicycle, a personal mobility, an airplane, a drone, a marine vessel, and a robot.

Hereinafter, one example of a case where the technology according to the present embodiment is applied to a movable object is described.

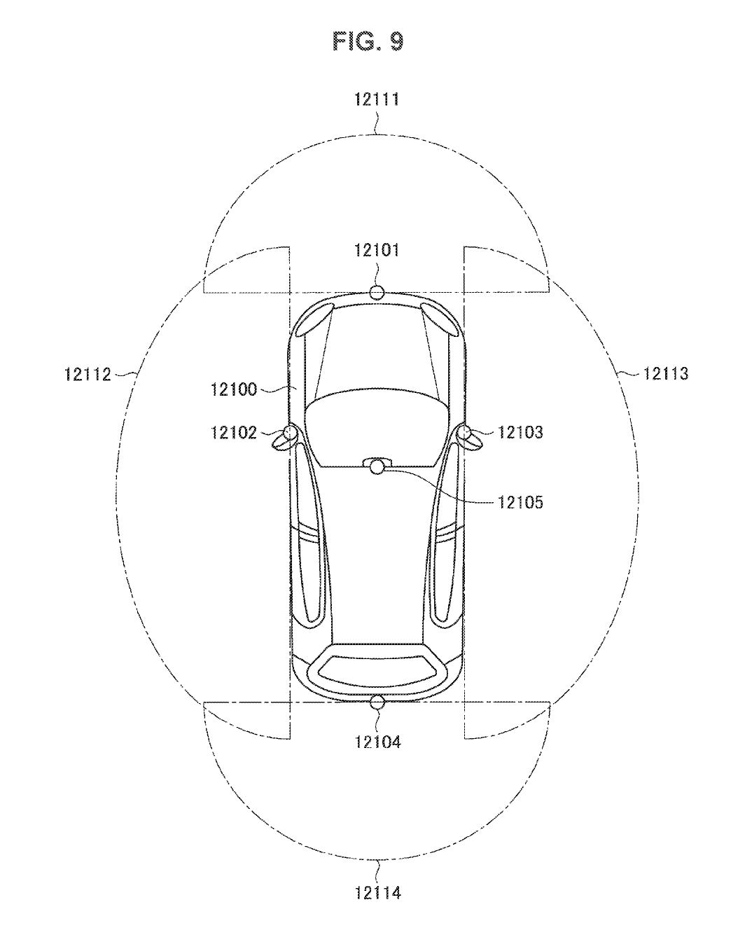

FIG. 9 is a block diagram illustrating a schematic configuration example of a vehicle control system which is an example of a mobile object control system to which a technology according to an embodiment of the present technology is applicable.

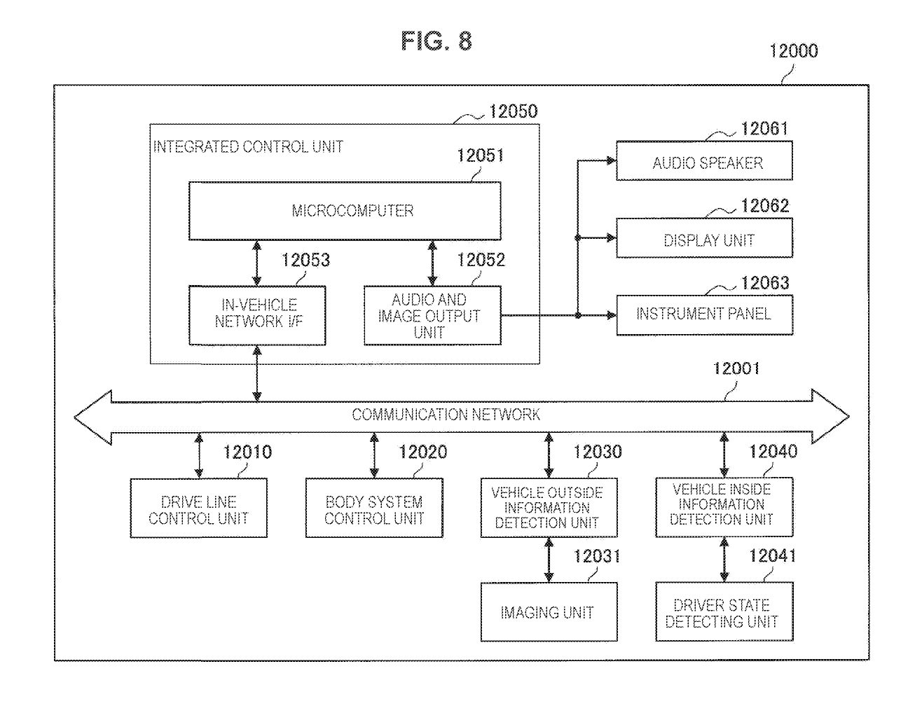

A vehicle control system 12000 includes a plurality of electronic control units connected via a communication network 12001. In the example illustrated in FIG. 8, the vehicle control system 12000 includes a drive line control unit 12010, a body system control unit 12020, a vehicle outside information detection unit 12030, a vehicle inside information detection unit 12040, and an integrated control unit 12050. In addition, as functional configurations of the integrated control unit 12050, a microcomputer 12051, an audio and image output unit 12052, an in-vehicle network interface (I/F) 12053.

The drive line control unit 12010 controls the operation of devices related to the drive line of the vehicle in accordance with a variety of programs. For example, the drive line control unit 12010 functions as a control device for a driving force generating device such as an internal combustion engine or a driving motor that generates the driving force of the vehicle, a driving force transferring mechanism that transfers the driving force to wheels, a steering mechanism that adjusts the steering angle of the vehicle, a braking device that generates the braking force of the vehicle, and the like.

The body system control unit 12020 controls the operations of a variety of devices attached to the vehicle body in accordance with a variety of programs. For example, the body system control unit 12020 functions as a control device for a keyless entry system, a smart key system, a power window device, or a variety of lights such as a headlight, a backup light, a brake light, a blinker, or a fog lamp. In this case, the body system control unit 12020 can receive radio waves transmitted from a portable device that serves instead of the key or signals of a variety of switches. The body system control unit 12020 receives these radio waves or signals, and controls the vehicle door lock device, the power window device, the lights, or the like.

The vehicle outside information detection unit 12030 detects information regarding the outside of a vehicle on which the vehicle control system 12000 is mounted. For example, an imaging unit 12031 is connected to the vehicle outside information detection unit 12030. The vehicle outside information detection unit 12030 causes the imaging unit 12031 to capture an image outside of the vehicle and receives the captured image. The vehicle outside information detection unit 12030 may perform an object detection process or a distance detection process for a person, a vehicle, an obstacle, a sign, letters on a road, or the like on the basis of the received image.

The imaging unit 12031 is a light sensor that receives light and outputs an electric signal in accordance with the amount of received light. The imaging unit 12031 can output the electric signal as an image or distance measurement information. In addition, the light received by the imaging unit 12031 may be the visible light or may be non-visible light such as infrared light.

The vehicle inside information detecting unit 12040 detects information regarding the inside of the vehicle. The vehicle inside information detecting unit 12040 is connected, for example, to a driver state detecting unit 12041 that detects the state of the driver. The driver state detecting unit 12041 may include, for example, a camera that images the driver. The vehicle inside information detecting unit 12040 may compute the degree of the driver's tiredness or the degree of the driver's concentration or determine whether the driver have a doze, on the basis of detection information input from the driver state detecting unit 12041.

For example, the microcomputer 12051 can calculate a control target value of the driving force generating device, the steering mechanism, or the braking device on the basis of information acquired by the vehicle outside information detecting unit 12030 or the vehicle inside information detecting unit 12040 on the inside and outside of the vehicle, and output a control instruction to the drive line control unit 12010. For example, the microcomputer 12051 may perform cooperative control for the purpose of executing the functions of an advanced driver assistance system (ADAS) including vehicle collision avoidance or impact reduction, follow-up driving based on the inter-vehicle distance, constant vehicle speed driving, vehicle collision warning, vehicle lane departure warning, or the like.

Further, the microcomputer 12051 can control the driving force generating device, the steering mechanism, the braking device, or the like on the basis of information acquired by the vehicle outside information detecting unit 12030 or the vehicle inside information detecting unit 12040 on the areas around the vehicle, thereby performing cooperative control for the purpose of automatic driving or the like that allows the vehicle to autonomously travel irrespective of any operation of a driver.

In addition, the microcomputer 12051 can output a control instruction to the body system control unit 12020 on the basis of the information regarding the outside of the vehicle acquired by the vehicle outside information detection unit 12030. For example, the microcomputer 12051 can control a head lamp in accordance with the position of a preceding vehicle or an oncoming vehicle detected by the vehicle outside information detection unit 12030 and can perform cooperative control for the purpose of anti-glaring such as switching a high beam to a low beam.

The audio and image output unit 12052 transmits an output signal of at least one of a sound and an image to an output device capable of visually or aurally notifying a passenger of the vehicle or the outside of the vehicle of information. In the example of FIG. 8, an audio speaker 12061, a display unit 12062, and an instrument panel 12063 are exemplified as the output device. For example, the display unit 12062 may include at least one of an onboard display and a head-up display.

FIG. 9 is a diagram illustrating an example of an installation position of the imaging unit 12031.

In FIG. 9, the vehicle 12100 includes imaging units 12101, 12102, 12103, 12104, and 12105 as the imaging unit 12031.

Imaging units 12101, 12102, 12103, 12104, and 12105 are positioned, for example, at the front nose, a side mirror, the rear bumper, the back door, and the upper part of the windshield in the vehicle compartment of a vehicle 12100. The imaging unit 12101 attached to the front nose and the imaging unit 12105 attached to the upper part of the windshield in the vehicle compartment chiefly acquire images of the area ahead of the vehicle 12100. The imaging units 12102 and 12103 attached to the side mirrors chiefly acquire images of the areas on the sides of the vehicle 12100. The imaging unit 12104 attached to the rear bumper or the back door chiefly acquires images of the area behind the vehicle 12100. A front image acquired by the imaging units 12101 and 12105 is used chiefly to detect a preceding vehicle, a pedestrian, an obstacle, a traffic light, a traffic sign, a lane, or the like.

Additionally, FIG. 9 illustrates an example of the imaging ranges of the imaging units 12101 to 12104. An imaging range 12111 represents the imaging range of the imaging unit 12101 attached to the front nose. Imaging ranges 12112 and 12113 respectively represent the imaging ranges of the imaging units 12102 and 12103 attached to the side mirrors. An imaging range 12114 represents the imaging range of the imaging unit 12104 attached to the rear bumper or the back door. For example, overlaying image data captured by the imaging units 12101 to 12104 offers an overhead image that looks down on the vehicle 12100.

At least one of the imaging units 12101 to 12104 may have a function of acquiring distance information. For example, at least one of the imaging units 12101 to 12104 may be a stereo camera including a plurality of image sensors or may be an image sensor that includes pixels for phase difference detection.

For example, the microcomputer 12051 can extract a 3-dimensional object traveling at a predetermined speed (for example, 0 or more km/h) in substantially the same direction as the vehicle 12100 as a preceding vehicle by particularly using a closest 3-dimensional object on a travel road of the vehicle 12100 by obtaining a distance to each 3-dimensonal object within the imaging ranges 12111 to 12114 and a temporal change in the distance (a relative speed to the vehicle 12100) on the basis of distance information obtained from the imaging units 12101 to 12104. Further, the microcomputer 12051 can set an inter-vehicle distance to be ensured in advance before a preceding vehicle and perform automatic brake control (also including follow-up stop control) or automatic acceleration control (also including follow-up oscillation control). In this way, it is possible to perform cooperative control for the purpose of automatic driving or the like that allows the vehicle to autonomously travel irrespective of any operation of a driver.

For example, the microcomputer 12051 can classify and extract 3-dimensional object data regarding 3-dimensional objects as other 3-dimensional objects such as motorcycles, normal vehicles, large vehicles, pedestrians, and electric poles on the basis of the distance information obtained from the imaging units 12101 to 12104 and can use the other 3-dimensional objects to automatically avoid obstacles. For example, the microcomputer 12051 identifies obstacles around the vehicle 12100 as obstacles which can be viewed by a driver of the vehicle 12100 and obstacles which are difficult to view. Then, the microcomputer 12051 can determine a collision risk indicating a danger of collision with each obstacle and output a warning to the driver via the audio speaker 12061 or the display unit 12062 in a situation in which there is a collision possibility since the collision risk is set to be equal to or greater than a set value or can perform driving assistance for collision avoidance by performing forced deceleration or avoidance steering iv via the drive line control unit 12010.

At least one of the imaging units 12101 to 12104 may be an infrared camera that detects infrared light. For example, the microcomputer 12051 can recognize a pedestrian by determining whether or not there is the pedestrian in captured images of the imaging units 12101 to 12104. The pedestrian can be recognized, for example, in a procedure in which feature points are extracted in the captured images of the imaging units 12101 to 12104 serving as infrared cameras and a procedure in which a series of feature points indicating a contour of an object are subjected to a pattern matching process to determine whether or not there is the pedestrian. The microcomputer 12051 determines that there is the pedestrian in the captured images of the imaging units 12101 to 12104. When the pedestrian is recognized, the audio and image output unit 12052 controls the display unit 12062 such that a rectangular contour line for emphasis is superimposed to be displayed on the recognized pedestrian. In addition, the audio and image output unit 12052 controls the display unit 12062 such that an icon or the like indicating the pedestrian is displayed at a desired position.

In the above, the one example of the vehicle control system in the case where the technology according to the present embodiment is applied to movable objects has been described. The technology according to the present embodiment may be applied to, for example, the imaging unit 12031 in the above-described vehicle control system.

### Program According to Present Embodiment

A program (for example, program that makes a computer execute processes related to the control method according to the first embodiment) for making a computer function as the control section 108 equipped in the imaging device 100 according to the first embodiment, is executed by the processor etc. in a computer, whereby the control of a gain in the imaging device 100 according to the first embodiment is realized. Therefore, by executing the program for making a computer function as the control section 108 equipped in the imaging device 100 according to the first embodiment by the processor etc. in a computer, it is possible to attain making the image quality of a captured image obtained by imaging, higher. Moreover, by executing the program for making a computer function as the control section 108 equipped in the imaging device 100 according to the first embodiment by the processor etc. in a computer, it is possible to attain the effects attained by the processes related to the control method according to the above-described first embodiment.

In addition, a program (for example, program that makes a computer execute processes related to the control method according to the second embodiment) for making a computer function as the control section 204 equipped in the imaging device 200 according to the second embodiment, is executed by the processor etc. in a computer, whereby control of a gain and control of switching of connection in the imaging device 200 according to the second embodiment is realized. Therefore, by executing the program for making a computer function as the control section 204 equipped in the imaging device 200 according to the second embodiment by the processor etc. in a computer, it is possible to attain making the image quality of a captured image obtained by imaging, higher. Moreover, by executing the program for making a computer function as the control section 204 equipped in the imaging device 200 according to the second embodiment by the processor etc. in a computer, it is possible to attain the effects attained by the processes related to the control method according to the above-described second embodiment.

Note that, in this description and the drawings, structural elements that have substantially the same function and structure are sometimes distinguished from each other using different alphabets after the same reference sign. However, when there is no need in particular to distinguish structural elements that have substantially the same function and structure, the same reference sign alone is attached.

For example, although it has been shown in the above to provide the program (computer program) for making a computer function as the control section 108 equipped in the imaging device 100 according to the first embodiment, it is also possible in the present embodiment to further provide, together with it, a recording medium made to memorize the above-described program. Moreover, for example, although it has been shown in the above to provide the program (computer program) for making a computer function as the control section 204 equipped in the imaging device 200 according to the second embodiment, it is also possible in the present embodiment to further provide, together with it, a recording medium made to memorize the above-described program.

The above-mentioned constitution shows one example of the present embodiment, and, naturally belongs to the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An imaging device, including:

an imaging section that includes a plurality of pixel circuits that perform photoelectric conversion;

a first converting section that converts an analog signal output from the pixel circuit that constitutes the imaging section, into a digital signal; and

a second converting section that converts an analog signal output from the pixel circuit that constitutes the imaging section, into a digital signal,

in which a same reference signal used for analog-to-digital conversion is supplied to the first converting section and the second converting section,

the first converting section and the second converting section convert the analog signal output from the same pixel circuit that constitutes the imaging section, into a digital signal, and

one or both of the first converting section and the second converting section is/are able to adjust a gain of the analog signal to be converted into a digital signal.

(2)

The imaging device according to (1), in which the reference signal is generated by a reference signal generator, and

a position at which the reference signal generator is disposed relative to the first converting section and wiring that connects the reference signal generator and the first converting section are symmetrical to a position at which the reference signal generator is disposed relative to the second converting section and wiring that connects the reference signal generator and the second converting section.

(3)

The imaging device according to (1) or (2), further including:

a first switching section that is electrically connected between the imaging section and the first converting section and switches the pixel circuit to be electrically connected to the first converting section; and

a second switching section that is electrically connected between the imaging section and the second converting section and switches the pixel circuit to be electrically connected to the second converting section,

in which the first converting section and the second converting section convert the analog signal output from the same pixel circuit that constitutes the imaging section, or the analog signal output from the different pixel circuits that constitute the imaging section, into a digital signal.

(4)

The imaging device according to (3), further including:

a control section that performs control of the gain in the first converting section capable of adjusting the gain, control of the gain in the second converting section capable of adjusting the gain, and control of switching of connection in the first switching section and the second switching section.

(5)

The imaging device according to (4), in which the control section performs control of the gain and control of switching of the connection on a basis of an operation signal corresponding to an operation of a user of the imaging device or a state of the imaging device.

(6)

The imaging device according to any one of (1) to (5), in which the first converting section includes a converting circuit that converts the analog signal into a digital signal. (7)

The imaging device according to (6), in which the converting circuit included in the first converting section capable of adjusting the gain includes a comparator, and the gain is adjusted by switching a capacitance ratio of capacitance to be connected to a terminal to which the reference signal is applied and capacitance to be connected to a terminal to be electrically connected to the pixel circuit in the comparator.

(8)

The imaging device according to any one of (1) to (7), in which the second converting section includes a converting circuit that converts the analog signal into a digital signal.

(9)

The imaging device according to (8), in which the converting circuit included in the second converting section capable of adjusting the gain includes a comparator, and the gain is adjusted by switching a capacitance ratio of capacitance to be connected to a terminal to which the reference signal is applied and capacitance to be connected to a terminal to be electrically connected to the pixel circuit in the comparator.

(10)

The imaging device according to any one of (1), (2), and (6) to (9), further including:

a control section that performs control of the gain in the first converting section capable of adjusting the gain and control of the gain in the second converting section capable of adjusting the gain.

(11)

The imaging device according to (10), in which the control section performs control of the gain on a basis of an operation signal corresponding to an operation of a user of the imaging device or a state of the imaging device.

(12)

A control method to be executed in an imaging device that includes

an imaging section that includes a plurality of pixel circuits that perform photoelectric conversion,

a first converting section that converts an analog signal output from the pixel circuit that constitutes the imaging section, into a digital signal,

a second converting section that converts an analog signal output from the pixel circuit that constitutes the imaging section, into a digital signal,

a first switching section that is electrically connected between the imaging section and the first converting section and switches the pixel circuit to be electrically connected to the first converting section, and

a second switching section that is electrically connected between the imaging section and the second converting section and switches the pixel circuit to be electrically connected to the second converting section,

in which a same reference signal used for analog-to-digital conversion is supplied to the first converting section and the second converting section,

the first converting section and the second converting section convert the analog signal output from the same pixel circuit that constitutes the imaging section, or the analog signal output from the different pixel circuits that constitute the imaging section, into a digital signal, and

one or both of the first converting section and the second converting section is/are able to adjust a gain of the analog signal to be converted into a digital signal,

the control method including:

a step of performing one or two or more of control of the gain in the first converting section capable of adjusting the gain, control of the gain in the second converting section capable of adjusting the gain, and control of switching of connection in the first switching section and the second switching section, on a basis of an operation signal corresponding to an operation of a user of the imaging device or a state of the imaging device.

### REFERENCE SIGNS LIST

100, 200 imaging device

102 imaging section

104A first converting section

104B second converting section

106 generating section

108, 204 control section

110 processing section

150 converting circuit

152 reference signal generating section

202A first switching section

202B second switching section

250 multiplexer

Comp comparator

P pixel circuit

1. An imaging device, comprising:
an imaging section that includes a plurality of pixel circuits that perform photoelectric conversion;
a first converting section that converts an analog signal output from the pixel circuit that constitutes the imaging section, into a digital signal; and
a second converting section that converts an analog signal output from the pixel circuit that constitutes the imaging section, into a digital signal,
wherein a same reference signal used for analog-to-digital conversion is supplied to the first converting section and the second converting section,
the first converting section and the second converting section convert the analog signal output from the same pixel circuit that constitutes the imaging section, into a digital signal, and
one or both of the first converting section and the second converting section is/are able to adjust a gain of the analog signal to be converted into a digital signal.

2. The imaging device according to claim 1, wherein the reference signal is generated by a reference signal generator, and
a position at which the reference signal generator is disposed relative to the first converting section and wiring that connects the reference signal generator and the first converting section are symmetrical to a position at which the reference signal generator is disposed relative to the second converting section and wiring that connects the reference signal generator and the second converting section.

3. The imaging device according to claim 1, further comprising:
a first switching section that is electrically connected between the imaging section and the first converting section and switches the pixel circuit to be electrically connected to the first converting section; and
a second switching section that is electrically connected between the imaging section and the second converting section and switches the pixel circuit to be electrically connected to the second converting section,
wherein the first converting section and the second converting section convert the analog signal output from the same pixel circuit that constitutes the imaging section, or the analog signal output from the different pixel circuits that constitute the imaging section, into a digital signal.

4. The imaging device according to claim 3, further comprising:
a control section that performs control of the gain in the first converting section capable of adjusting the gain, control of the gain in the second converting section capable of adjusting the gain, and control of switching of connection in the first switching section and the second switching section.

5. The imaging device according to claim 4, wherein the control section performs control of the gain and control of switching of the connection on a basis of an operation signal corresponding to an operation of a user of the imaging device or a state of the imaging device.

6. The imaging device according to claim 1, wherein the first converting section includes a converting circuit that converts the analog signal into a digital signal.

7. The imaging device according to claim 6, wherein the converting circuit included in the first converting section capable of adjusting the gain includes a comparator, and the gain is adjusted by switching a capacitance ratio of capacitance to be connected to a terminal to which the reference signal is applied and capacitance to be connected to a terminal to be electrically connected to the pixel circuit in the comparator.

8. The imaging device according to claim 1, wherein the second converting section includes a converting circuit that converts the analog signal into a digital signal.

9. The imaging device according to claim 8, wherein the converting circuit included in the second converting section capable of adjusting the gain includes a comparator, and the gain is adjusted by switching a capacitance ratio of capacitance to be connected to a terminal to which the reference signal is applied and capacitance to be connected to a terminal to be electrically connected to the pixel circuit in the comparator.

10. The imaging device according to claim 1, further comprising:
a control section that performs control of the gain in the first converting section capable of adjusting the gain and control of the gain in the second converting section capable of adjusting the gain.

11. The imaging device according to claim 10, wherein the control section performs control of the gain on a basis of an operation signal corresponding to an operation of a user of the imaging device or a state of the imaging device.

12. A control method to be executed in an imaging device that includes
an imaging section that includes a plurality of pixel circuits that perform photoelectric conversion,
a first converting section that converts an analog signal output from the pixel circuit that constitutes the imaging section, into a digital signal,
a second converting section that converts an analog signal output from the pixel circuit that constitutes the imaging section, into a digital signal,
a first switching section that is electrically connected between the imaging section and the first converting section and switches the pixel circuit to be electrically connected to the first converting section, and
a second switching section that is electrically connected between the imaging section and the second converting section and switches the pixel circuit to be electrically connected to the second converting section,
wherein a same reference signal used for analog-to-digital conversion is supplied to the first converting section and the second converting section,
the first converting section and the second converting section convert the analog signal output from the same pixel circuit that constitutes the imaging section, or the analog signal output from the different pixel circuits that constitute the imaging section, into a digital signal, and
one or both of the first converting section and the second converting section is/are able to adjust a gain of the analog signal to be converted into a digital signal,
the control method comprising:
a step of performing one or two or more of control of the gain in the first converting section capable of adjusting the gain, control of the gain in the second converting section capable of adjusting the gain, and control of switching of connection in the first switching section and the second switching section, on a basis of an operation signal corresponding to an operation of a user of the imaging device or a state of the imaging device.
